(19) United States
(12) Patent Application Publication
(10) Pub. No.: US 2007/0160962 A1
(43) Pub. Date: Jul. 12, 2007

(54) System and method for software training from a bootable media

(76) Inventors: John L. Jones, Georgetown, TX (US); Scott Purcell, Austin, TX (US)

Correspondence Address: HAMILTON & TERRILE, LLP, P.O. BOX 203518, AUSTIN, TX, 78720, US

(21) Appl. No.: 11/328,778

(22) Filed: Jan. 10, 2006

(51) Int. Cl. G09B 19/00

(52) U.S. Cl. 434/118

(57) ABSTRACT

An information handling system having a configured operating system boots to a removable medium to provide a training environment and training material for a training operating system. Training content runs over the training operating system so that an end user has access to functions of the training operating system for applying training material. A training operating system provided from the removable medium loads from the removable medium into RAM on the information handling system and runs without impacting the configured operating system or other system settings at a subsequent reboot of the information handling system. The training material is presented by a browser running over the training operating system to allow retrieval of network based material, such as exams.

### BACKGROUND OF THE INVENTION

1. Field of the Invention

The present invention relates in general to the field of information handling system end user training, and more particularly to a system and method for software training at an information handling system from a bootable media.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling system components have grown more powerful, software application designers have leveraged the greater processing capability of these components to build more complex functions. For instance, greater CPU operating speeds allow applications to process information more quickly, greater RAM size and speed keeps information more quickly accessible by the CPU and greater hard disk drive size allows storage of larger applications in permanent memory. As a result, applications and operating systems have grown in size and complexity over the past several years with the addition of a variety of functions that find varying degrees of use by end users. One result of the increased functionality of software applications is that end users tend to configure their information handling system with hardware and software preferences that make desired functionality more accessible. End users tend to avoid adding applications to their information handling system after the system is configured in a desired way out of fear that added applications will alter the operating characteristics of the system. In particular, end users are hesitant to alter the operating system of an information handling system since the operating system typically manages a number of user preferences.

In a competitive information processing industry, it is sometimes necessary or advantageous for end users to become familiar with information processing solutions that differ from their familiar choices. One example of this is the growing popularity of the Linux operating system as an alternative to commercially-available operating systems, such as the various versions of WINDOWS. Although Linux offers broad functionality as an operating system, it also tends to require greater user familiarity to use effectively. A basic Linux operating system kernel will, for instance, run a networking application on an information handling system server with good reliability, however, the end user typically must have sufficient familiarity with the Linux environment and commands to bring the application to an operational state. Thus, one impediment to more widespread adoption of the Linux operating system has been a lack of end user comfort and familiarity with Linux in an operational state. In order to build end user comfort and familiarity, training tools attempt to simulate Linux while running on a WINDOWS operating system. Such simulations are helpful in that they recreate a LINUX environment, however, since the underlying operating system actually supports the simulator, the end user gets no real experience with Linux. Additionally, a simulator can only provide responses for actions the developer anticipates that an end user might take. Other possible actions will not provide meaningful responses or accurate training experiences. The end user can obtain actual experience by loading Linux on an information handling system and running Linux without WINDOWS, however, end users are hesitant to do so since loading and running Linux may have an undesired impact on the configuration and preferences of the information handling system.

### SUMMARY OF THE INVENTION

Therefore a need has arisen for a system and method which provides training for an operating system on an information handling system with minimal lasting impact on the configuration of the information handling system.

In accordance with the present invention, a system and method are provided which substantially reduce the disadvantages and problems associated with previous methods and systems for training an end user in an operating system on an information handling system. An information handling system boots from a removable medium having a training operating system. The training operating system loads from the removable medium to RAM to run a training application with direct interaction available to the end user in the training operating system environment. Execution of the training operating system in RAM avoids alterations to permanent memory of the information handling system.

More specifically, an optical medium stores a training operating system, such as Linux, designed to run from the optical medium or RAM, and training material for end user training in the training operating system. On power up of an information handling system having the optical medium inserted in an optical drive, an operating system kernel detects local hardware to coordinate initial operation of the information handling system. The training operating system loads in RAM and with access to the optical drive to run the information handling system and support presentation of the training materials as well as a command prompt for direct user interaction with the training operating system. Training material is, for instance a browser and plural pages of instructional material located on the optical medium or at a network location. Once an end user has completed interaction with the training material and desires to return the information handling system to its normally configured state, the optical medium is removed and the system rebooted to a configured operating system stored on its hard disk drive, thus removing all vestiges from RAM of the training operating system.

The present invention provides a number of important technical advantages. One example of an important technical advantage is that an end user trains in a Linux operating system environment with Linux running on an information handling system but with minimal lasting impact on the configuration of the information handling system. Thus, the end user has an opportunity for hands on experience with the operating system while the operating system runs the information handling system but without changing the configuration of the information handling system. Once the training session completes or at the end user's convenience, the end user simply reboots to remove the RAM disk with the Linux operating system and to reinitiate the configured operating system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system and a training removable medium for training an end user in use of a training operating system;

FIG. 2 depicts a flow diagram of a process for bringing an information handling system to an operational state from a training removable medium;

FIG. 3 depicts a flow diagram of a process for training an end user in a training operating system running on an information handling system; and

FIG. 4 depicts an example of a training presentation of training operating system instructional material.

### DETAILED DESCRIPTION

Initiating a training operating system from a removable medium in RAM defined in an information handling system provides end user training in the training operating system without impacting a configured operating system and associated settings stored in permanent memory. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

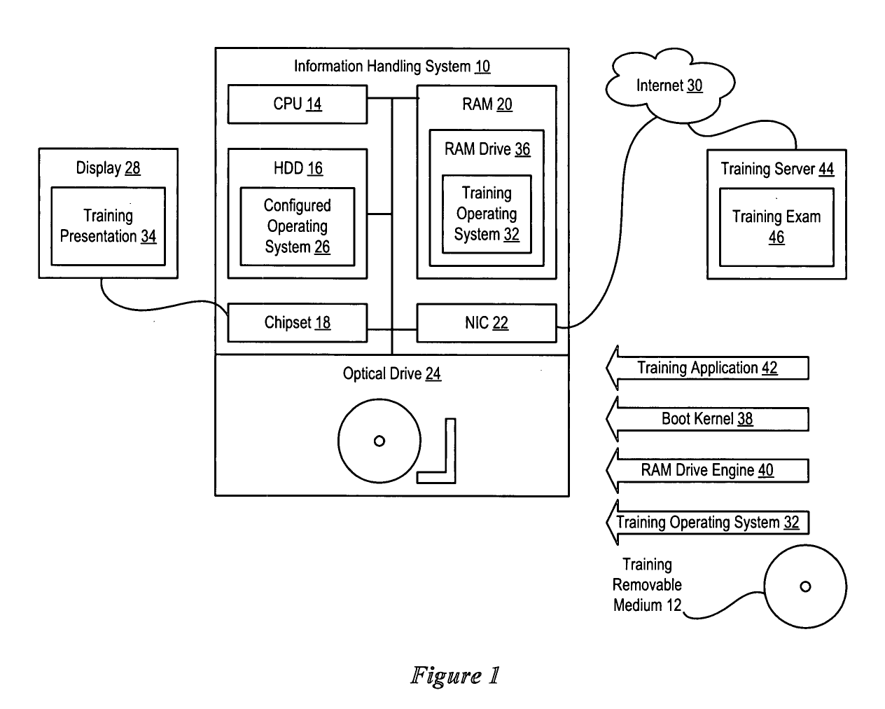

Referring now to FIG. 1, a block diagram depicts an information handling system 10 and a training removable medium 12 for training an end user in use of a training operating system. Information handling system 10 has plural processing components for processing information, such as a CPU 14, hard disk drive (HDD) 16, chipset 18, RAM 20, network interface card (NIC) 22 and optical drive 24. Under ordinary operating conditions, a configured operating system 26, such as WINDOWS, stored in hard disk drive 16 is retrieved during power up by firmware instructions in chipset 18, such as a BIOS, and loaded into RAM 20 to coordinate operation of the various processing components. Information generated by the processing components is rendered for presentation at a display 28 by graphics components in chipset 18 or a separate graphics card. The processing components communicate with a network, such as Internet 30, through NIC 22 and communicate with removable optical media through optical drive 24.

Training removable medium 12 includes a copy of a training operating system 32, such as Linux, and training material to provide instruction to an end user in the training operating system as a training presentation 34 rendered at display 28. However, the training operating system and configured operating system cannot operate simultaneously on information handling system 10. In addition, loading training operating system 32 in permanent storage of information handling system 10, such as hard disk drive 16, may have unintended negative consequences on configured operating system 26. To minimize any lasting impact of training operating system 32 on information handling system 10, training operating system 32 is loaded directly into RAM 20 without copying, installing or storing information in hard disk drive 16. In one embodiment, a RAM drive 36 is defined in RAM 20 to allow loading of training operating system 32 in a defined area of RAM 20, for instance so as to reduce or eliminate the use of optical medium during operation of the system. When information handling system 10 is powered down, such as with a reboot, volatile RAM 20 erases the loaded training operating system 32 and allows normal system power up and boot to configured operating system 26 with no lasting effects by the loading of training operating system 32.

Training removable medium 12 is an optical medium, such a Compact Disc (CD) or Digital Versatile Disc (DVD), which stores instructions for automatically loading training operating system 32 and supporting training presentation 34. Training removable medium 12 is inserted in an optical drive 24 that is checked as a bootable medium by chipset 18 during power up of information handling system 10. The training operating system 32 loads into RAM 20, provides basic coordination of processing components and then loads the training application 42 from optical medium 12. For instance, a boot kernel 38 initially loads to detect hardware and automatically run a RAM drive engine 40, such as the “initial ramdrive” (initrd) command used by Linux or by calling the open source Knoppix application. In one embodiment, RAM drive engine 40 defines a RAM drive within RAM 20 that is identified and used by training operating system 32 much as any other hard disk drive or optical drive is identified and used. RAM drive 36 is defined with adequate room to load training operating system 32 followed by training application 42. Training application 42 is, for example, a browser and plural pages of instructional material presented by the browser as training presentation 34. In addition, the browser of training application 42 supports presentation of information retrieved from a training server 44 through Internet 30, such as a training exam to test end user competency in the training operating system.

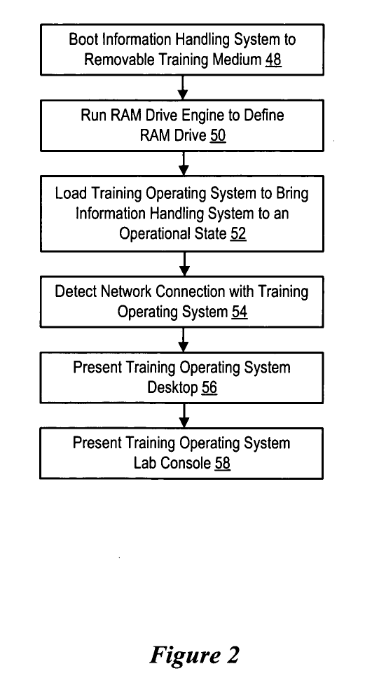

Referring now to FIG. 2, a flow diagram depicts a process for bringing an information handling system to an operational state from a training removable medium. The process begins at step 48 with boot of an information handling system to a removable training medium having the training operating system and training material. In one embodiment, step 50 is performed with a RAM drive engine defining and creating a RAM drive in RAM of the information handling system to load the training operating system and desired portions of the training material. At step 52, the training operating system is loaded in the RAM drive to bring the information handling system to an operational state under management of the training operating system. The loading of the training operating system from the optical medium into RAM without installation to the hard disk drive avoids writes to permanent storage of the information handling system that might disrupt the configured operating system. At step 54, the training operating system detects network connections to support network communications. At step 56, a training operating system desktop is presented and at step 58, a laboratory console is presented that allows the end user of the information handling system to directly interact with the training operating system, such as to practice using functions of the training operating system.

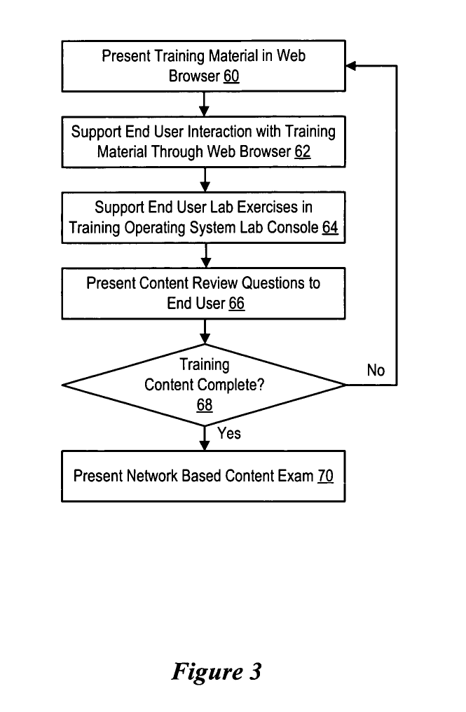

Referring now to FIG. 3, a flow diagram depicts a process for training an end user in a training operating system running on an information handling system. The process begins by presentation of training material in a web browser running over the training operating system, such as automated loading of desired pages from the removable medium. At step 62, end user interaction with training material is supported through the web browser, such as ordered presentation of pages having training material defined by a syllabus. At step 64, end user lab exercises are supported in the training operating system laboratory console so that the user may apply concepts from training material with direct interaction with the training operating system. At step 66, a content review is presented to the end user to ensure mastery of instructional material, such as with review questions, and at step 68 a determination is made of whether the training content is completed. If additional training content remains, the process returns to step 60. If the presentation of the training material is complete, the process continues to step 70 for presentation of a network based content exam that tests end user mastery of material. Retrieving mastery exam material from a network location allows security for test material and tracking of end user completion of training material. In alternative embodiments, various pages of material may be downloaded from a network location and end user progress through the materials may be tracked at a web site as content is completed.

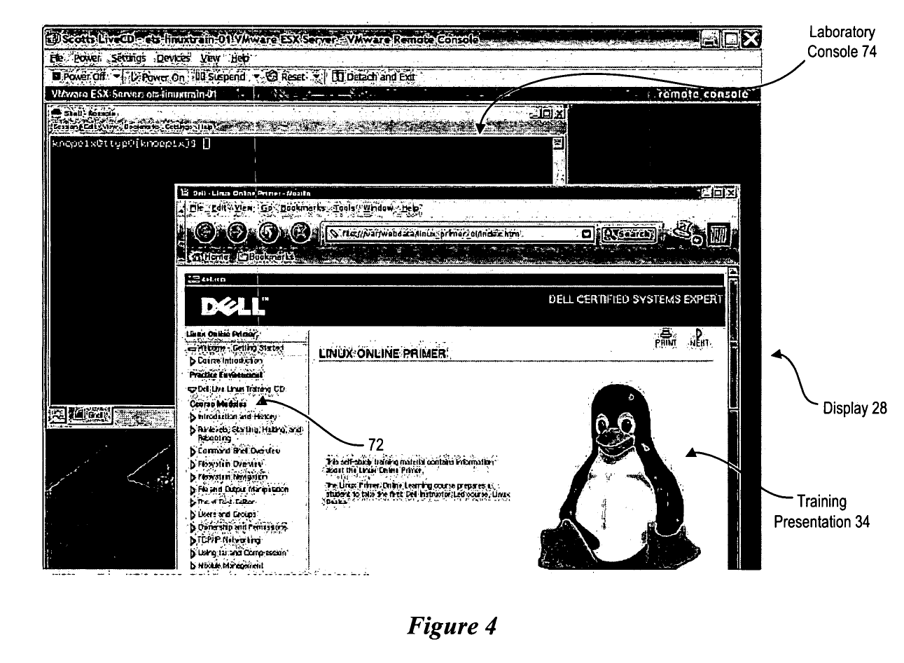

Referring now to FIG. 4, an example is depicted of a training presentation of training operating system instructional material. Display 28 renders a training presentation 34 as a web browser with content retrieved as pages from a syllabus with defined course modules 72. The content pages are retrieved from the RAM drive, the removable medium or an on-line networked location. A laboratory console 74 presents a command line prompt for Linux to allow the end user to apply material from training presentation 34 with commands in a Linux environment.

Although the present invention has been described in detail, it should be understood that various changes, substitutions and alterations can be made hereto without departing from the spirit and scope of the invention as defined by the appended claims.

What is claimed is:

1. A method for training an end user in a training operating system on an information handling system, the information handling system having a configured operating system, the method comprising:
interfacing a removable medium with the information handling system;
booting the information handling system from the removable medium;
loading the training operating system into RAM;
running the information handling system with the training operating system; and
automatically initiating a training application to instruct in the use of the operating system on the information handling system.

2. The method of claim 1 further comprising:
removing the removable medium from the information handling system; and
rebooting the information handling system to remove the training operating system from RAM.

3. The method of claim 1 wherein the training operating system comprises Linux.

4. The method of claim 1 wherein the removable medium comprises an optical medium.

5. The method of claim 4 wherein automatically initiating a training application further comprises:
retrieving the training application from the optical medium;
running the training application on the training operating system; and
performing training operating system functions in response to the training application.

6. The method of claim 1 wherein automatically initiating a training application further comprises:
establishing a network connection;
retrieving a training application from the network; and
running the training application on the training operating system.

7. The method of claim 6 wherein the training application comprises an exam on the use of the training operating system.

8. A system for training an end user in a training operating system, the system comprising:
an removable storage medium storing instructions readable by an information handling system, the instructions comprising:
a boot kernel operable to boot an information handling system to an operational state;
a training operating system operable to load in RAM and run the information handling system without alteration of permanent storage; and
a training application operable to run on the information handling system over the training operating system to instruct an end user in use of the operating system.

9. The system of claim 8 wherein the removable storage medium comprises an optical medium.

10. The system of claim 8 wherein the training operating system comprises Linux.

11. The system of claim 8 wherein the training application is further operable to provide access to training operating system commands for end user training.

12. The system of claim 8 wherein the training application comprises a browser and plural pages of training information presentable by the browser.

13. The system of claim 12 wherein the training application further comprises at least one networked page of training information, the training operating system operable to establish a network connection for retrieval of the networked page.

14. The system of claim 13 wherein the networked page comprises a competency exam for determining competency in the training operating system.

15. An information handling system comprising:
plural processing components operable to process information;
a display interfaced with the processing components and operable to present the information;
a configured operating system stored on one or more of the processing components and operable to load at power up of the processing components to coordinate operation of the processing components;
a removable medium drive operable to accept a removable medium and to read information stored on the removable medium; and
a removable medium having a training operating system, the training operating system operable to load in RAM to coordinate the operation of the processing components in the place of the configured operating system, the training application operable to present training information at the display for end user training in the training operating system.

16. The information handling system of claim 1 wherein the training application is further operable to provide end user access to functions performed by the training operating system.

17. The information handling system of claim 15 wherein the training application comprises a browser and plural pages of training information for presentation to an end user.

18. The information handling system of claim 17 wherein the training operating system is further operable to connect to a network and the training application further comprises networked pages.

19. The information handling system of claim 18 wherein the training operating system comprises Linux.

20. The information handling system of claim 18 wherein the networked pages comprise testing material for testing end user training in the training operating system.
